(19) United States
(12) Patent Application Publication
(10) Pub. No.: US 2010/0142194 A1
(43) Pub. Date: Jun. 10, 2010

(54) AUTOMOTIVE LAMP LIGHTING SYSTEM

(75) Inventor: Osamu Masuda, Shizuoka (JP)

Correspondence Address: FULWIDER PATTON LLP, HOWARD HUGHES CENTER, 6060 CENTER DRIVE, TENTH FLOOR, LOS ANGELES, CA, 90045, US

(73) Assignee: KOITO MANUFACTURING CO., LTD., Tokyo (JP)

(21) Appl. No.: 12/631,668

(22) Filed: Dec. 4, 2009

(30) Foreign Application Priority Data
Dec. 5, 2008 (JP) 2008-311539

(51) Int. Cl. F21L 4/00

(52) U.S. Cl. 362/183

(57) ABSTRACT

An automotive lamp lighting system includes a rear combination lamp, a secondary battery for storing electric power to be supplied to the rear combination lamp, a solar battery for generating electric power to be stored in the secondary battery or electric power to be supplied to the rear combination lamp, and a control module for controlling the supply of electric power from the solar battery and the secondary battery to the rear combination lamp in response to a state of lighting of the rear combination lamp.

### CROSS-REFERENCE TO RELATED APPLICATION

This application is based upon and claims the benefit of priority from the prior Japanese Patent Application No. 2008-311539, filed on Dec. 5, 2008, the entire content of which is incorporated herein by reference.

### BACKGROUND OF THE INVENTION

1. Field of the Invention

The present invention relates to a technology for controlling the lighting of lamps used in an automobile or the like.

2. Description of the Related Art

In recent years, there has been a trend toward increased electric power consumption by an automobile along with the on-going sophistication of automobile functions and electrical equipment. Thus demand has been growing for electric power saving and higher efficiency of various functional units used in an automobile. For example, Japanese Patent Application Publication No. Hei05-225801 discloses an automotive lamp having a solar battery disposed in the back side of a transparent reflector which recovers part of the light energy of the light source of a headlamp as electrical energy for charging the battery.

Also, Japanese Utility Model Publication No. Hei06-45208 discloses an energy recovery system using a solar battery disposed in the lamp chamber which converts the light energy, other than the part used effectively in forming a desired distribution pattern, in the light flux exiting from a light source bulb of an automotive lamp into electrical energy to charge the battery.

Such systems as described above, however, have a problem that the electric power generated by the solar battery is recovered directly by a vehicular battery and is not used directly to turn on the light source of the lamp.

### SUMMARY OF THE INVENTION

The present invention has been made in view of the foregoing circumstances, and a purpose thereof is to provide a technology that enables lighting of automotive lamps with as little dependence on power supply from a body-side battery as possible.

To resolve the foregoing problems, an automotive lamp lighting system according to one embodiment of the present invention comprises: an automotive lamp; a secondary battery configured to store electric power to be supplied to the automotive lamp; a solar battery configured to generate electric power to be stored in the secondary battery or electric power to be supplied to the automotive lamp; and a control module configured to control the supply of electric power from the solar battery and the secondary battery to the automotive lamp in response to a state of lighting of the automotive lamp.

By employing this embodiment, the power required by the automotive lamp can be supplemented with power generated by the solar battery. Thus the automotive lamp can be lit up with as little dependence on power supply from a body-side battery or the like as possible. In other words, the frequency of charge and discharge of the battery on a vehicular body can be reduced. Moreover, when there is more power generated by the solar battery than the power consumed by the automotive lamp, the automotive lamp lighting system allows storing of the surplus power in the secondary battery and then supplies electric power to the automotive lamp not only from the solar battery but also from the secondary battery according as necessity arises. As a result, even when the power generation by the solar battery drops temporarily, it is possible to light up the automotive lamp with as little dependence on power supply from the body-side battery or the like as possible.

### BRIEF DESCRIPTION OF THE DRAWINGS

Embodiments will now be described by way of examples only, with reference to the accompanying drawings which are meant to be exemplary, not limiting and wherein like elements are numbered alike in several Figures in which:

FIG. 1 is an overall view of automotive lamps according to a first embodiment of the present invention as viewed from the rear of an automobile;

FIG. 2 is a front view of a rear combination lamp according to a first embodiment;

FIG. 3 is a cross-sectional view taken along line A-A of FIG. 2;

FIG. 4 is a cross-sectional view taken along line B-B of FIG. 2;

FIG. 5 is a block diagram of an automotive lamp lighting system according to a first embodiment; and

FIG. 6 is a front view of a headlamp according to a second embodiment of the present invention.

### DETAILED DESCRIPTION OF THE INVENTION

The invention will now be described by reference to the preferred embodiments. This does not intend to limit the scope of the present invention, but to exemplify the invention.

Hereinbelow, a detailed description will be given of best modes for carrying out the invention with reference to the drawings. Note that in the description of Figures the same reference numerals are assigned to the same components and the repeated description thereof is omitted as appropriate.

### FIRST EMBODIMENT

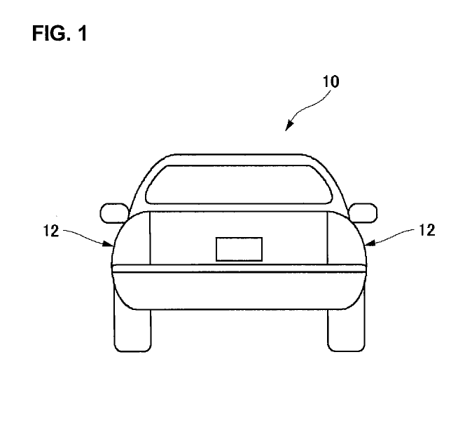

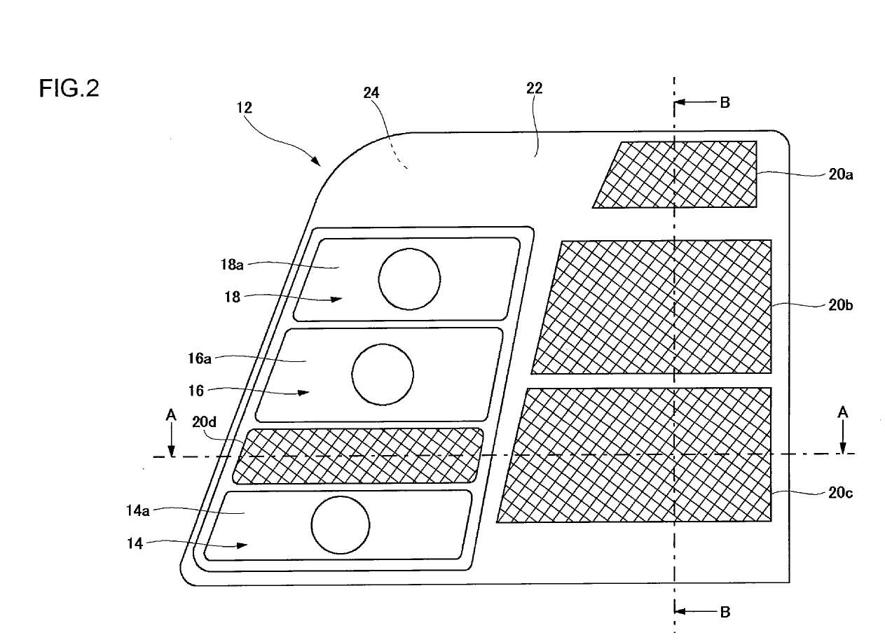

FIG. 1 is an overall view of automotive lamps according to a first embodiment of the present invention as viewed from the rear of a vehicle such as an automobile. As shown in FIG. 1, a pair of right and left rear combination lamps 12 is provided on the back of a vehicle 10. FIG. 2 is a front view of a rear combination lamp according to the first embodiment. Each rear combination lamp (hereinafter abbreviated as RCL) 12 is comprised integrally of a first lamp unit 14, which has a tail lamp and a stop lamp to emit red light, a second lamp unit 16, which has a back up lamp to emit white light, and a third lamp unit 18, which has a turn signal lamp to emit amber light.

An RCL 12 is equipped with a plurality of solar battery panels 20a, 20b, 20c and 20d in the regions other than those where the first lamp unit 14, second lamp unit 16, and third lamp unit 18 are disposed. Also, the RCL 12 is equipped with a front cover lens 22 which covers the entirety of the first lamp unit 14, second lamp unit 16, and third lamp unit 18 and the plurality of solar battery panels 20a, 20b, 20c and 20d. The front cover lens 22 is preferably made of a material that exhibits high transmission rate of light of wavelengths suited to the power generation by the solar battery. An extension 24 is provided in the periphery of the openings of lamp chambers 14a, 16a and 18a of the first lamp unit 14, second lamp unit 16 and third lamp unit 18, respectively. Note here that the extension 24, which is a part covering the periphery of the reflector of each lamp unit, may be plated or coated as appropriate in accordance with the design of the automobile.

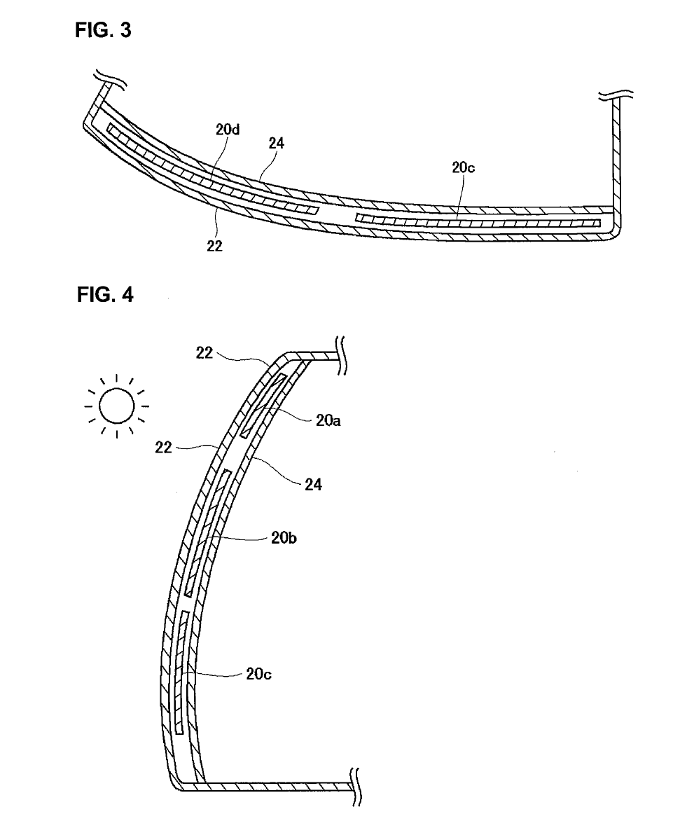

FIG. 3 is a cross-sectional view taken along line A-A of FIG. 2. FIG. 4 is a cross-sectional view taken along line B-B of FIG. 2. As shown in FIG. 3 and FIG. 4, the solar battery panels 20a, 20b, 20c and 20d are placed between the front cover lens 22 and the extension 24 which is a dummy part not functioning as an illumination component. This arrangement makes it possible to dispose the solar battery panels without causing interference with the irradiation regions of the lamp units. Also, the solar battery panels 20a and 20b are placed in a tilted manner such that the surfaces thereof exposed to sunlight face upward as shown in FIG. 4. This improves the power generation efficiency of the solar battery.

Note that the solar battery according to the first embodiment includes the solar battery panels 20a, 20b and 20c which face different directions from each other. Accordingly, there may be a greater likelihood of one of the solar battery panels facing the sun even when there is change in the position of the vehicle or the sun. As a result, there will be reduced variations in the power generation by the solar battery. In other words, while there may be fewer instances where electric power surpassing a desired level necessary to light up the lamp is outputted by the solar battery, there may also be fewer instances where electric power supplied from the solar battery does not reach the desired level. As a result, there will be reduced demand for electric power to be supplied from a secondary battery for lamp units, whose function is to supplement the power for lighting the lamps when the power supplied by the solar battery is not enough. This means reduced discharge from the secondary battery and therefore a longer life for the secondary battery.

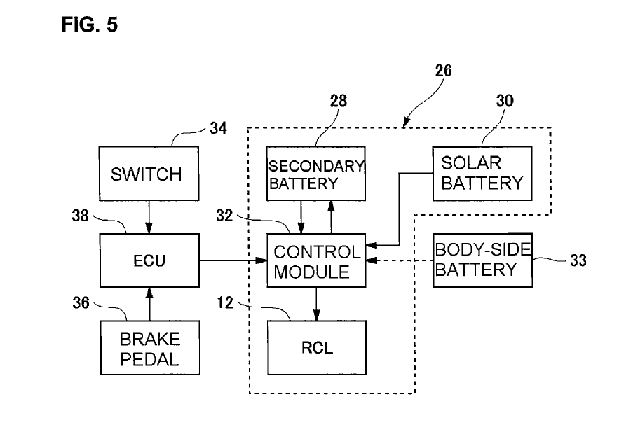

Now a description will be given of an automotive lamp lighting system that is equipped with the aforementioned RCL 12 as automotive lamps. The automotive lamp lighting system relies mainly on the solar battery in performing lighting control for the lamps in the system. FIG. 5 is a block diagram of an automotive lamp lighting system according to the present embodiment.

The automotive lamp lighting system 26 includes an RCL 12, a secondary battery 28 for lamps, which stores electric power to be supplied to the RCL 12, a solar battery 30, which generates electric power to be stored in the secondary battery 28 or electric power to be supplied to the automotive lamp, and a control module 32, which controls the supply of electric power from the solar battery 30 and the secondary battery 28 to the RCL 12 in response to the state of lighting of the RCL 12. It is to be noted that the automotive lamp lighting system 26 according to the present embodiment is connected to a body-side battery 33 in preparation for instances when the power supplied from the secondary battery 28 or the solar battery 30 does not reach a power level required by the RCL 12.

The solar battery 30 has the aforementioned plurality of solar battery panels 20a, 20b, 20c and 20d. The control module 32 receives operation signals for a lamp lighting switch 34 or a brake pedal 36 provided on a vehicular body via a body-side ECU (Electronic Control Unit) 38 and controls the supply of electric power to each lamp unit of the RCL 12 from the solar battery 30 and the secondary battery 28 in response to the signals.

The automotive lamp lighting system 26, which can supplement the power required by the RCL 12 with power generated by the solar battery 30, makes it possible to light the various lamp units of the RCL 12 with as little dependence on power supply from the body-side battery or the like as possible. In other words, the automotive lamp lighting system 26 can reduce the frequency of charge and discharge of the battery on the vehicular body. Moreover, when there is more power generated by the solar battery 30 than the power consumed by the RCL 12, the system allows storing of the surplus power in the secondary battery 28 and then supplies electric power to the RCL 12 not only from the solar battery 30 but also from the secondary battery 28 as occasion demands. As a result, even when the power generation by the solar battery 30 drops temporarily, it is possible to light up the RCL 12 by the automotive lamp lighting system 26 with as little dependence on power supply from the body-side battery or the like as possible.

The RCL 12, as meant herein, includes a turn signal lamp to be turned on at lane change or right or left turn, a stop lamp to be turned on when the brake pedal is stepped on at braking, and a back up lamp to be turned on at backing up the vehicle, as lamp units that indicate changes in the traveling condition of the vehicle. These lamps only have to light up when there is some change in the traveling condition of the vehicle and therefore do not remain lit while the vehicle is running normally. Hence, in the vehicular lamp lighting system 26 equipped with these lamps, the solar battery 30 or the secondary battery 28 may be used as a principal source of power, so that the lighting of these lamps can be accomplished in a self-contained manner with little dependence on the body-side battery.

In particular, use of LED or like lamps of low power consumption (electric power saving type) as the light source may enable the use of a low-output solar battery or a small-capacity secondary battery, which will help make the system as a whole lighter and reduce the cost thereof. Also, use of LEDs of colors suited to the respective functions of the lamps may enable the use of a transparent cover as the front cover lens 22. Such an arrangement may allow the light of a wide range of wavelengths to pass through the front cover lens 22, thereby improving the power generation efficiency of the solar battery 30. Furthermore, since the LEDs do not produce much heat, the components such as the secondary battery 28 and the control module 32 can be placed around the LEDs, which enhances the freedom of layout.

The secondary battery 28 according to the present embodiment is installed in the RCL 12 independently of the body-side battery 33, which is a main storage battery equipped on the vehicle. For example, structural integration can be accomplished if the secondary battery 28 is installed on the back face of a lamp unit of the RCL 12. At the lighting of the RCL 12, the control module 32 gives priority to the supply of power from the solar battery 30. Such an arrangement enables the lighting of the RCL 12 with power generated by the solar battery 30 with as little consumption of power from the secondary battery 28 as possible. In other words, giving priority to the power supply from the solar battery 30 lightens the load of charge and discharge of the secondary battery 28, consequently making the life of the secondary battery 28 longer.

The control module 32 has a path for connecting to the body-side battery 33. When there is any shortage of power supplied from the solar battery 30 and the secondary battery 28 to light up the RCL 12, the control module controls the supplementary supply of power to the RCL 12 from the body-side battery 33 in response to the power shortage. In this manner, the RCL 12 is lit reliably as required even when there is a shortage of power supply from the solar battery 30 and the secondary battery 28 thereto.

Note that the control module 32 also performs the control to prevent full charge of the secondary battery 28, the control of power supply from the body-side battery 33 in an emergency situation, and the control of charging the secondary battery 28 from the solar battery 30 while the RCL 12 is not lit.

### SECOND EMBODIMENT

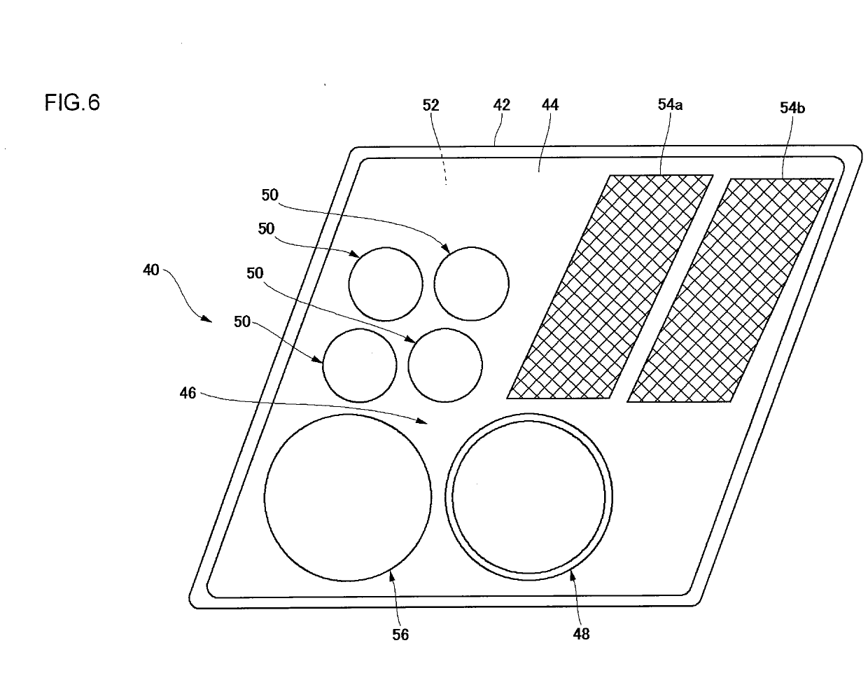

In a second embodiment of the present invention, a description will be given of an example in which the above-described automotive lamp lighting system is applied to headlamps. FIG. 6 is a front view of a headlamp according to a second embodiment of the present invention. The headlamp 40 according to the second embodiment includes a lamp body 42 and a translucent cover 44, which is mounted on the front opening of the lamp body 42. Housed in a lamp chamber 46 formed by the lamp body 42 and the translucent cover 44 are a low beam lamp unit 48 to form a low beam distribution pattern and four high beam lamp units 50 to form their respective high beam distribution patterns.

The high beam lamp units 50, which are each an LED lamp, include an LED module, which is a light source with an LED (Light Emitting Diode) sealed by a transparent resin cover, a lamp housing containing the LED module, a support plate for supporting the LED module in the lamp housing, a reflector of a predetermined reflection surface shape disposed inside the lamp housing, and a cover lens of a predetermined shape disposed at the front opening of the lamp housing.

An extension 52 is provided in the periphery of the opening of the lamp chamber 46 which houses the low beam lamp unit 48 and the high beam lamp units 50. And solar battery panels 54a and 54b are placed between the translucent cover 44 and the extension 52 which is a dummy part not functioning as an illumination component.

The headlamp 40 according to the second embodiment further includes a DRL (Daytime Running Lights) unit 56 which are the lamps mainly used in the daytime. Note, however, that the automotive lamp lighting system may be equipped with turn signal lamps instead of the DRL unit 56. Also, note that LEDs are preferred as light sources for the lamps. In the automotive lamp lighting system 26 equipped with such light sources, the electric power supplied from the solar battery 30 or the secondary battery 28, which is better suited to power generation in the daytime, is used mainly, so that the lighting of the lamps can be accomplished in a self-contained manner with little dependence on the body-side battery 33.

According to the present embodiment, therefore, the automotive lamps can be lit with as little dependence on the power supply from the body-side battery 33 as possible.

The present invention has been described by referring to each of the above-described embodiments. However, the present invention is not limited to the above-described embodiments only, and those resulting from any combination of them as appropriate or substitution are also within the scope of the present invention. Also, it is understood by those skilled in the art that various modifications such as changes in the order of combination or processings made as appropriate in each embodiment or changes in design may be added to the embodiments based on their knowledge and the embodiments added with such modifications are also within the scope of the present invention.

In addition to the above-described rear combination lamp unit and headlamp unit, the automotive lamp according to the present embodiments is also applicable to a fog lamp, a cornering lamp, a clearance lamp, a turn signal lamp, a highmount stop lamp, a license-plate lamp, a back up lamp and so forth.

What is claimed is:

1. An automotive lamp lighting system comprising:
an automotive lamp;
a secondary battery configured to store electric power to be supplied to the automotive lamp;
a solar battery configured to generate electric power to be stored in the secondary battery or electric power to be supplied to the automotive lamp; and
a control module configured to control the supply of electric power from the solar battery and the secondary battery to the automotive lamp in response to a state of lighting of the automotive lamp.

2. An automotive lamp lighting system according to claim 1, wherein the secondary battery is provided on the automotive lamp independently of a main storage battery of a vehicle,
wherein the automotive lamp and the secondary battery are both electric power saving type, and
wherein the control module gives priority to the supply of electric power from the solar battery at the lighting of the automotive lamp.

3. An automotive lamp lighting system according to claim 1, wherein the solar battery is disposed between an extension, which is located in the periphery of an opening of a lamp chamber in the automotive lamp, and a cover.

4. An automotive lamp lighting system according to claim 2, wherein the solar battery is disposed between an extension, which is located in the periphery of an opening of a lamp chamber in the automotive lamp, and a cover.

5. An automotive lamp lighting system according to claim 1, wherein the solar battery has a plurality of battery panels which are oriented in different directions from each other.

6. An automotive lamp lighting system according to claim 2, wherein the solar battery has a plurality of battery panels which are oriented in different directions from each other.

7. An automotive lamp lighting system according to claim 3, wherein the solar battery has a plurality of battery panels which are oriented in different directions from each other.

8. An automotive lamp lighting system according to claim 1, wherein the control module has a path for connecting to the main storage battery of a vehicle, and
when there is a shortage of power supplied from the solar battery and the secondary battery to light up the automotive lamp, the control module controls the supply of power to the automotive lamp from the storage battery in response to the shortage of power.

9. An automotive lamp lighting system according to claim 2, wherein the control module has a path for connecting to the main storage battery of a vehicle, and
when there is a shortage of power supplied from the solar battery and the secondary battery to light up the automotive lamp, the control module controls the supply of power to the automotive lamp from the storage battery in response to the shortage of power.

10. An automotive lamp lighting system according to claim 3, wherein the control module has a path for connecting to the main storage battery of a vehicle, and
when there is a shortage of power supplied from the solar battery and the secondary battery to light up the automotive lamp, the control module controls the supply of power to the automotive lamp from the storage battery in response to the shortage of power.

11. An automotive lamp lighting system according to claim 5, wherein the control module has a path for connecting to the main storage battery of a vehicle, and
when there is a shortage of power supplied from the solar battery and the secondary battery to light up the automotive lamp, the control module controls the supply of power to the automotive lamp from the storage battery in response to the shortage of power.

12. An automotive lamp lighting system according to claim 1, wherein the solar battery is placed in a tilted manner such that the surface thereof exposed to sunlight face upward.

13. An automotive lamp lighting system according to claim 1, wherein the automotive lamp is a lamp that indicates a change in a traveling condition of a vehicle.

14. An automotive lamp lighting system according to claim 1, wherein the automotive lamp is a lamp mainly used in the daytime.
